(19) United States
(12) Patent Application Publication
(10) Pub. No.: US 2017/0165825 A1
(43) Pub. Date: Jun. 15, 2017

(54) MULTIPURPOSE HAND TOOLS AND TOOL HANDLES

(71) Applicant: Kegan Douglas Ross, Merriam, KS (US)

(72) Inventor: Kegan Douglas Ross, Merriam, KS (US)

(21) Appl. No.: 15/381,082

(22) Filed: Dec. 15, 2016

Related U.S. Application Data
(60) Provisional application No. 62/386,885, filed on Dec. 15, 2015.

(51) Int. Cl. B25G 1/10; B25G 1/08; F21V 33/00; B26B 11/00; B25B 13/46; B25B 23/16; B25F 1/00; B25F 1/02

(52) U.S. Cl. CPC B25G 1/105; B25F 1/006; B25G 1/085; B25F 1/02; B26B 11/00; B25B 13/461; B25B 23/16; F21V 33/0084

(57) ABSTRACT

The present invention relates to tools with wrenches and sockets recessed into the sides of the tool handles. The handles can be of any shape and applicable to any tool that uses a handle. Each side of a handle can contain a socket or wrench of different size so that one tool can include a complete set of sockets or wrenches.

### BACKGROUND OF THE INVENTION

A. Field of the Invention

The present invention relates to tools. More specifically, the invention relates to hand tools having handles with built-in sockets and wrenches.

B. Description of the Related Art

Wrenches and sockets are well-known for being used to provide grip and mechanical advantage in applying torque to tighten or loosen fasteners, such as nuts and bolts. But because nearly all screws, nuts, and bolts have multiple types and sizes, multiple types and sizes of wrenches and sockets are needed. Unfortunately, it is not uncommon for users to misplace one or more wrenches or sockets from a set because most sets can be easily separated. As a result, time and money are lost in trying to find or replace missing wrenches and sockets.

Additionally, wrenches are often used in conjunction with other hand tools. Users are often required to carry multiple tools together, which can contribute to more easily misplacing one or more wrenches or sockets. Such losses are increasingly easy to occur with smaller tools. These sets are costly and take up storage and transportation space. Time is often lost in finding and swapping the separate tools that are necessary to complete a task.

### SUMMARY OF THE INVENTION

The present invention provides multiple tools that are incorporated into a single device. Advantageously, the invention reduces the likelihood of misplaced tools and uses storage and transportation space more efficiently. Further, the invention allows for time to be more efficiently used because tools sets are less likely to become separated.

The invention incorporates wrenches and sockets into the handle of another tool. Each side of a tool handle can have a different size wrench or socket built directly into it. The wrench ends and sockets are cut directly into the sides of the handle as if indented or embedded into the material forming the handle.

Tools incorporating handles of the invention have a first section that has one function, such as a hammer, ax, screwdriver, or other hand tool, and a second section that comprises a handle that also includes one or more different functions.

Embodiments of the invention include a tool handle that has at least one socket recessed into at least one side of the handle, and the socket is fixed in the recessed position. Advantageously, the socket is usable in its fixed position. Thus, a user may rapidly switch from one operation, such as using a screwdriver, to another operation, i.e. using a socket, without having to exchange one tool for a separate tool.

Certain embodiments of the invention include tool handles that have two or more sockets recessed and fixed into at least one side of a handle. Preferred embodiments of the invention include tool handles that have two or more sockets recessed and fixed into two or more sides of a handle. It is preferred that a set of sockets are present in a handle.

Tool handles of the invention can also include at least one wrench recessed into an end of at least one side of a handle, and the wrench is fixed into the side of the handle. Certain embodiments of the invention include tool handles that have a wrench recessed and fixed into an end of two or more sides of the handle.

Preferred embodiments of the invention include one or more sockets and one or more wrenches in a handle. More preferred embodiments include two or more sockets and two or more wrenches in a handle.

Tool handles of the invention may be attached to a wide variety of hand tools. Exemplary hand tools include, but are not limited to, a screwdriver, hammer, flashlight, chisel, knife, utility knife, or ratchet. Preferred hand tools have handles that comprise a single member or body, most commonly an elongated body or member.

It is expected that sockets or wrenches incorporated into the invention can be of different sizes. Preferably, a set of sockets and a set of wrenches are incorporated into handles of the invention.

Tool handles can be of a variety of shapes and sizes. A preferred shape is an elongated shape. Alternatively, tool handles incorporating the invention can be ovoid or spherical shaped. Handles of the invention can have 3, 4, 5, 6, 7, or 8 sides.

In some embodiments, hand tools of the invention comprise a first section having a screwdriver and a second section having a handle, wherein the handle has at least one socket recessed into at least one side and the socket is fixed.

Some screwdrivers that incorporate handles of the invention can be retracted into the handle. In such embodiments the handle includes a hollowed core suitable for housing a screwdriver for storage. That is, a first section of the hand tool is retractable into a second section that comprises a handle that has two or more sockets recessed and fixed into one or more sides of the handle. The second section can also include a wrench fixed and recessed into an end of at least one side of the handle, or the second section can have a wrench fixed and recessed into an end of two or more sides of the handle.

Hand tools of the invention comprise a first section having a handle, wherein the handle has at least one socket recessed into at least one side and the socket is fixed, and a second section comprising a hammer, flashlight, chisel, knife, utility knife, or ratchet. The first section can further include a wrench fixed and recessed into an end of at least one side of the handle. Preferably, a set of sockets and a set of wrenches are present in the second section of the hand tool. Hand tools of the invention that have a second section comprising a hammer or ax can further include one or more sockets and one or more wrenches that are embedded or molded into the head of the hammer or ax.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description presented herein.

FIG. 1. is a lateral view of a multi-tasking tool with six sides and a Phillips-head (crosshead) screwdriver.

FIG. 2 is a lateral view of a multi-tasking tool with six sides and a flat (slot) screwdriver.

FIG. 3 is a lateral view of a multi-tasking tool with four sides and a Phillips-head screwdriver.

FIG. 4 is a lateral view of a multi-tasking tool with four sides and a flat screwdriver.

FIG. 5 is a front side perspective view of a multi-tasking tool with six sides and a Phillips-head screwdriver.

FIG. 6 is a front side perspective view of a multi-tasking tool with six sides and a flat screwdriver.

FIG. 7 is a rear side perspective view of a multi-tasking tool with six sides and a Phillips-head screwdriver.

FIG. 8 is a rear side perspective view of a multi-tasking tool with six sides and a flat screwdriver.

FIG. 9 is a front side perspective view of a multi-tasking tool with four sides and a Phillips-head screwdriver.

FIG. 10 is a front side perspective view of a multi-tasking tool with four sides and a flat screwdriver.

FIG. 11 is a rear side perspective view of a multi-tasking tool with four sides and a Phillips-head screwdriver.

FIG. 12 is a rear side perspective view of a multi-tasking tool with four sides and a flat screwdriver.

FIG. 13 is a side perspective view of a razor or utility knife with built in sockets and wrenches.

FIG. 14 is a side view of a flashlight with built in sockets and wrenches.

FIG. 15 is a side view of a ratchet tool with built in sockets and wrenches.

FIG. 16A is a side view of a hammer with built in sockets and wrenches. FIG. 16B is a rear perspective view of a back portion of a hexagonal-shaped handle.

### DETAILED DESCRIPTION

The invention provides for the integration of wrenches and sockets into the handles of hand tools, such as screwdrivers, ratchets, flashlights, axes, utility knives, and hammers, that have a handle section formed by a single piece or body.

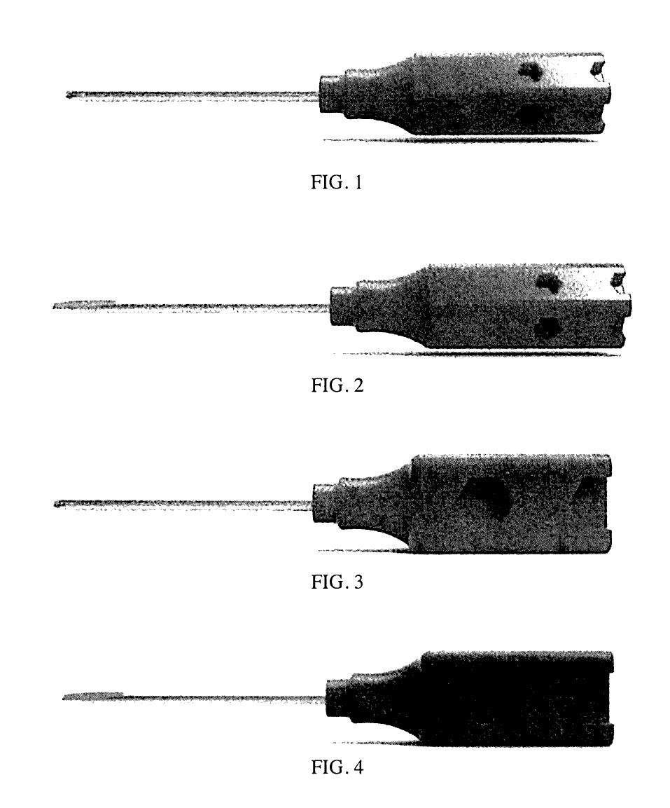

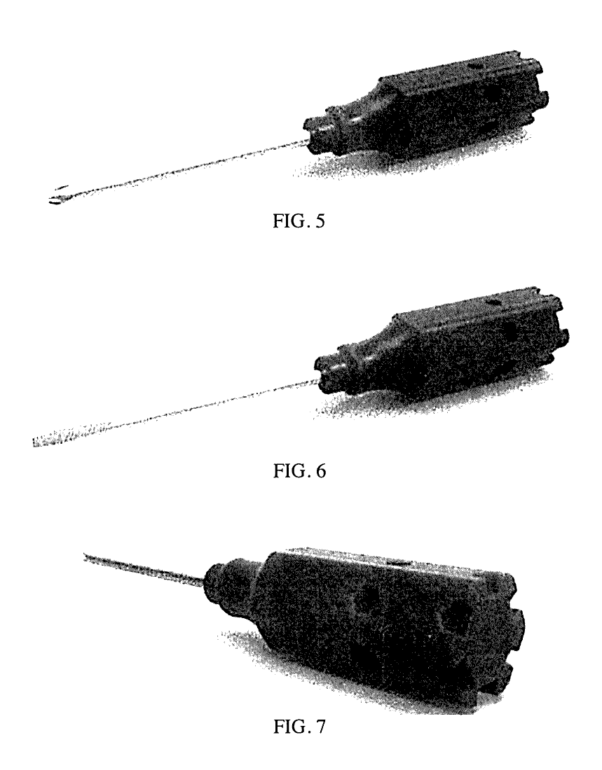

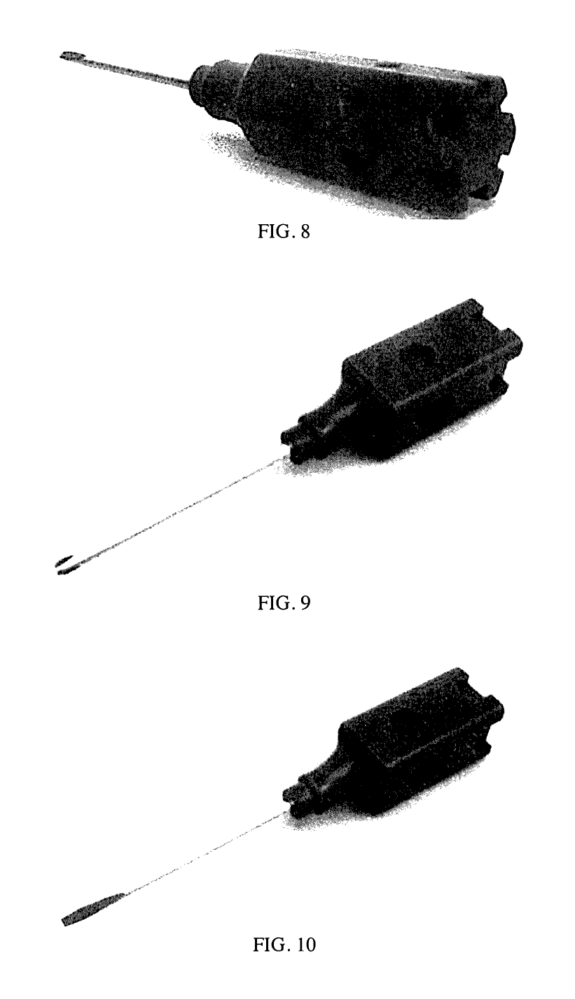

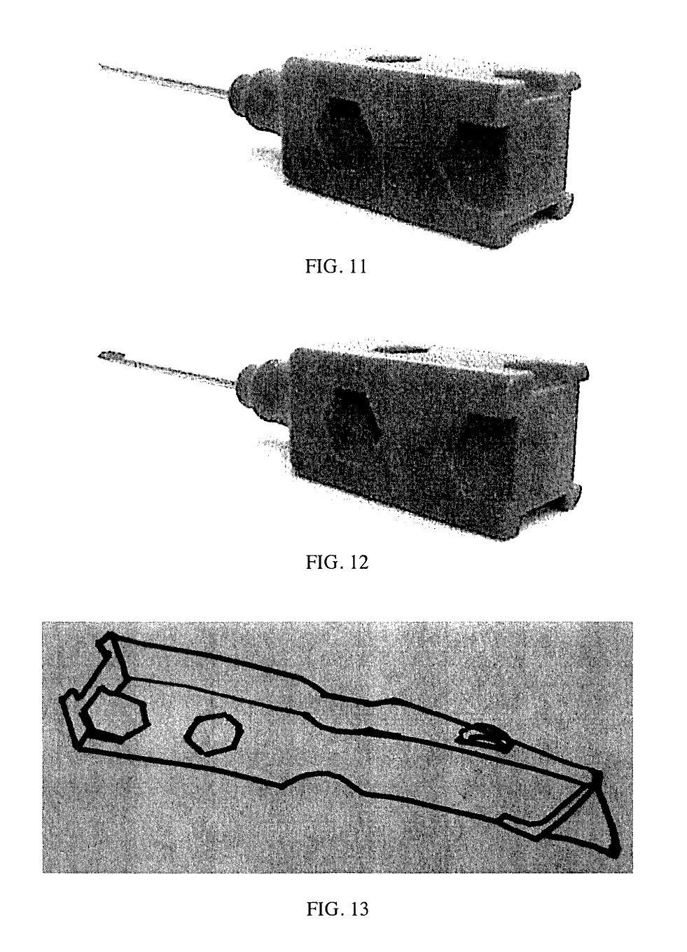

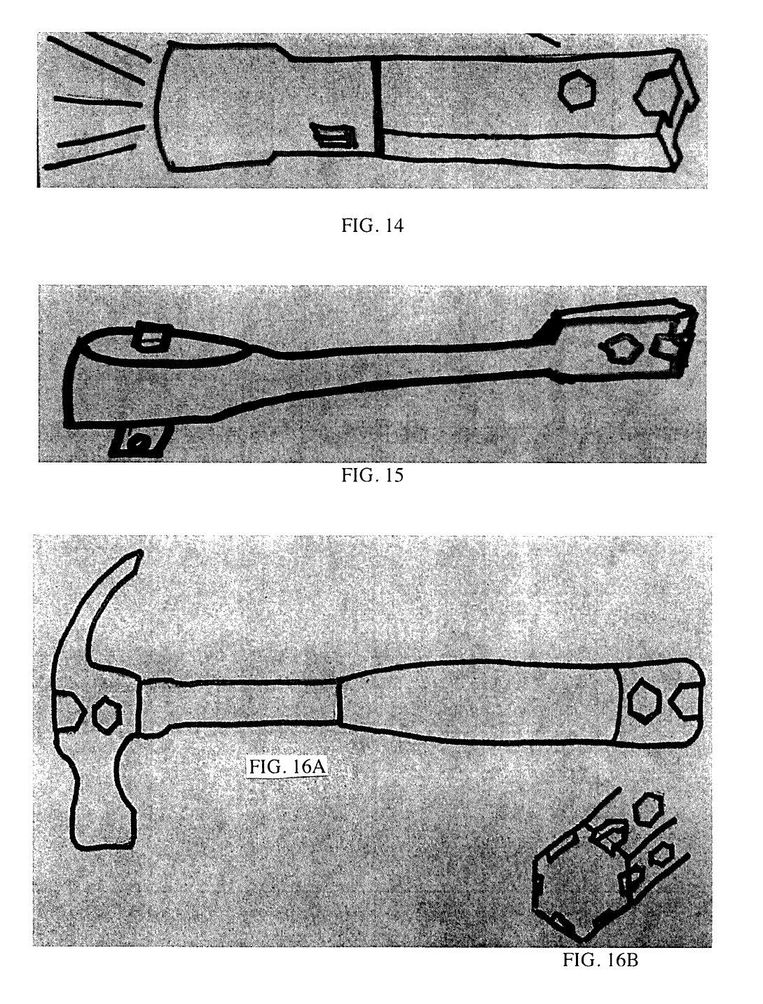

Unlike current wrenches that store a variety of sockets in their handles, the sockets of the present invention do not need to be removed from the handle and inserted into an end piece for use. Instead, the sockets of the present invention are permanently fixed into the body of the handle such that they are usable in place. Similarly, a variety wrenches can be included in the handle section of a tool so that the wrenches are also permanently fixed and usable in place. Advantageously, a member of a socket set or set of wrenches cannot be separated from the handle and misplaced from the other members of the set. It is envisioned that hand tools incorporating handles of the invention are principally used to tighten or loosen relatively smaller sized fasteners rather than fasteners that require powered or large sized tools to generate sufficient torque to either tighten or loosen the fasteners. A variety of exemplary tools having sockets and wrenches fixed in their handles are shown in FIGS. 1-16A.

As shown in FIGS. 1-12, screwdrivers having handles that include one or more sockets or wrenches can be made in a variety of shapes. For example, FIGS. 1, 2, and 5-8 illustrate handles that are shaped to have six sides, and FIGS. 3, 4, and 9-12 illustrate handles that are shaped to have four sides. Alternative handle shapes and configurations are illustrated in FIGS. 13-16A. FIG. 16B illustrates one configuration from a rear perspective. Those of skill in the art will recognize that multiple handle shapes can be used for a variety of tools. Handles can have more or less sides than those illustrated. That is, a handle can have 3, 4, 5, 6, 7, 8, 9, 10, or more sides. Preferred handles have 3, 4, 5, 6, 7, or 8 sides. The number of sides that a handle can have is limited by the overall size of the handle, as well as, the size(s) of the sockets or wrenches that are to be recessed into the handle.

Preferably, the handle section has an overall elongated shape, but those of skill in the art will appreciate that the handle section may have an overall ovoid or spherical shape. Sides of the handle section having a socket or wrench recessed into it may have a flattened surface adjacent to the socket or wrench. Alternatively, the area of a side of a handle that is adjacent to a socket or wrench may curve away from the socket or wrench. If the area is curved, then it is curved such that the area does not interfere with the coupling of the socket or wrench to a fastener.

Herein, a socket is a “female” recess, indentation, niche, depression, or opening that receives another object, i.e. a fastener, such that together the fastener may be loosened or tightened. Sockets, as well as wrenches, can be in fractional inch (SAE) and metric sizes, and in short (shallow) and longer (deep) varieties.

Sockets may include convex walls and other similar optimizations to the socket geometry in an effort to minimize the difficulty in working with fasteners that have been stripped or have had their sharp angles rounded. Such sockets allow for the applied torque to be spread away from the corners of fasteners and instead target the thicker, more reinforced areas of a nut or bolt head.

In some embodiments, handles of the invention include spline sockets that have a ridge in the center of the side wall of the socket and contact the fastener at the approximate midpoint of the side. Such sockets allow increased torque to be applied without damaging the fastener head.

Several sizes of wrenches and sockets can be made into the handles of screwdrivers and other tools so that each side of the handle has a different size. For example, if the handle is hexagonal, one side can have a wrench or socket size starting at 4 mm or ¼ SAE, and each subsequent side being the next size wrench in a set of wrenches or sockets. One handle can then contain a set of 4 mm, 5 mm, 6 mm, 7 mm, 8 mm, and 9 mm or ¼ inch, 5/16 inch, ⅜ inch, 7/16 inch, ½ inch, and 9/16 inch wrenches or sockets. It is recommended that screwdrivers with such handles include either a #1 Phillips-head for metric size wrenches or a #1 slotted screwdriver head for SAE sizes. Alternatively, handles can have larger sized wrenches or sockets, such as 10 mm, 11 mm, 12 mm, 13 mm, 14 mm, and 15 mm or ⅝ inch, 11/16 inch, ¾ inch, 13/16 inch, ⅞ inch, and 1-inch. It is recommended that screwdrivers with such handles include either a #2 Phillips-head or #2 slotted tip. Larger size handles may only have four sides to accommodate larger size wrenches or sockets such as 16 mm, 17 mm, 18 mm, 19 mm, or larger SAE sizes. It is recommended that screwdrivers with such handles include either a #3 Phillips-head or slotted size tip.

The handles can be made in any of a variety of ways known in the art. Handles can be made of any suitable material. For example, handles may be made of molded plastics, rubbers, metals, alloys, wood, or any combination thereof. If desired, handles can be made with metal inserts to strengthen their overall structure.

A socket or wrench may be molded, stamped, or otherwise shaped into a handle by using current manufacturing techniques that are used in the art. The specific choice of manufacture will be influenced by the material used to make a handle, costs, and the number of handles to be made. Those of skill in the art will be aware of other factors that will influence the choice of manufacturing technique.

Optionally, handles can be removable from the hand tool to allow the use of both ends of a tool simultaneously or to insert a different handle onto a tool. For example, a user may want to interchange metric and SAE handles on a hammer or other hand tool. Similarly, a user may want to interchange Phillips-head (crosshead) and slot (flat) head screwdrivers onto metric and SAE handles of the invention.

In some embodiments of the invention, handles that are incorporated into screwdrivers can allow for the screwdriver section to retract into the handle for easier storage. Such handles include a hollowed interior suitable for storing the screwdriver section. Those of skill in the art will be familiar with the various types of snapping, locking, or screwing options that are currently available and that are suitable for retracting the screwdriver section into a handle of the invention.

Unless defined otherwise, all technical and scientific terms used herein have the same meaning as is commonly understood by one of skill in the art to which this invention belongs at the time of filing. The meaning and scope of terms should be clear; however, in the event of any latent ambiguity, definitions provided herein take precedent over any dictionary or extrinsic definition. Further, unless otherwise required by context, singular terms shall include pluralities and plural terms shall include the singular. Herein, the use of “or” means “and/or” unless stated otherwise. Furthermore, the use of the term “including”, as well as other forms such as “includes” and “included” is not limiting.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the following claims.

What is claimed is:

1. A tool handle having at least one socket recessed into at least one side of the handle and the socket is fixed.

2. The tool handle of claim 1, wherein two or more sockets are recessed and fixed into one or more sides of the handle.

3. The tool handle of claim 1, further comprising at least one wrench recessed into an end of at least one side of the handle, wherein the wrench is fixed.

4. The tool handle of claim 3, wherein a wrench is recessed and fixed into an end of two or more sides of the handle.

5. The tool handle of claim 1, wherein the handle is attached to a hand tool.

6. The tool handle of claim 5, wherein the hand tool is a screwdriver, hammer, ax, flashlight, chisel, knife, utility knife, or ratchet.

7. The tool handle of claim 2, wherein the sockets are of different sizes.

8. The tool handle of claim 4, wherein the wrenches are of different sizes.

9. The tool handle of claim 1, wherein the handle is an elongated shape.

10. The tool handle of claim 1, wherein the handle is an overall ovoid or spherical shape.

11. The tool handle of claim 1, wherein the handle has 3, 4, 5, 6, 7, or 8 sides.

12. A hand tool comprising a first section having a screwdriver and a second section having a handle, wherein the handle has at least one socket recessed into at least one side and the socket is fixed.

13. The hand tool of claim 12, wherein the first section is retractable into the second section.

14. The hand tool of claim 12, wherein the handle has two or more sockets recessed and fixed into one or more sides of the handle.

15. The hand tool of claim 12, wherein the second section has a wrench fixed and recessed into an end of at least one side of the handle.

16. The tool handle of claim 14, wherein the sockets are of different sizes.

17. The tool handle of claim 15, wherein the second section has a wrench fixed and recessed into an end of two or more sides of the handle.

18. The tool handle of claim 17, wherein the wrenches are of different sizes.

19. A hand tool comprising a first section having a handle, wherein the handle has at least one socket recessed into at least one side and the socket is fixed, and a second section having a hammer, ax, flashlight, chisel, knife, utility knife, or ratchet.

20. The hand tool of claim 19, wherein the first section further includes a wrench fixed and recessed into an end of at least one side of the handle.
